(19) United States
(12) Patent Application Publication
(10) Pub. No.: US 2008/0141224 A1
(43) Pub. Date: Jun. 12, 2008

(54) DEBUG INFORMATION COLLECTION METHOD AND DEBUG INFORMATION COLLECTION SYSTEM

(76) Inventors: Shinichiro Kawasaki, Kamakura (JP); Toru Nojiri, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/947,221

(22) Filed: Nov. 29, 2007

(30) Foreign Application Priority Data
Dec. 1, 2006 (JP) 2006-325922

(51) Int. Cl. G06F 11/36

(52) U.S. Cl. 717/127

(57) ABSTRACT

In a software distribution unit, a binary-code analysis unit determines a total set of insertion positions at which probes can be inserted into software. A binary-code change unit determines the population of insertion positions of probes to be inserted into the software and the number of insertion positions of probes to be inserted on a device basis. Then, the binary-code change unit selects, from the population, insertion positions of probes as many as the determined number of insertion positions and inserts the probes into the software at the selected insertion positions. A software distribution unit distributes, to the device, the software into which the probes are inserted. As a result, it is possible to reduce both a load on the device side and a load on the software developer side at the same time and to acquire uniform debug information without deviations.

### CLAIM OF PRIORITY

The present application claims priority from Japanese application serial no. JE 2006-325922, filed on Dec. 1, 2006, the content of which is hereby incorporated by reference into this application.

### BACKGROUND OF THE INVENTION

The present invention relates to a method for collecting debug information of software that is particularly distributed to a large number of devices connected through networks so that the software is executed by each of the devices, the debug information being used to improve the quality of the software.

Software size is increasing in information processing equipment, which is so-called built-in equipment. The information processing equipment includes home information appliances and portable telephones. The reason the software size is increasing in the information processing equipment is that manufacturers are required to achieve many new functions by use of software in a short period of time as a result of the addition of network-supported functions, the increase in user's requests, and the like. With the increase in size of software, the manufactures are more seriously required to ensure the quality of software. However, because it is difficult to spend the extra time to ensure the quality, some measures are also taken: for example, updating software after the shipment of a product.

Examples of technique for ensuring the quality of software include a technique in which probes used to check the progress in the execution are inserted into software so that debug information is collected. For example, there are techniques including: coverage for reviewing executed and unexecuted portions of the software; and assertions for examining truth values of each conditional statement specified by a developer. However, built-in equipment with insufficient computing resources cannot fulfill a request to increase a storage area when necessary and a request to cope with performance overheads. Therefore, it is not possible to insert a large number of probes.

For the purpose of dealing with this problem, Japanese Patent Laid-Open Publication No. JP-A-6-161825 (patent document 1) discloses a technique in which a user is allowed to specify a range within which each probe is inserted so that the each probe is automatically inserted within the specified range. In this technique, the problems with a memory area and execution time are avoided by limiting a range within which each probe is inserted. Although information to be collected is also limited, it is possible to collect the required amount of debug information by repeatedly collecting debug information with the probe insertion range changed.

In addition, Ben Liblit et al. “Bug Isolation via Remote Program Sampling” PLDI '03, Jun. 9-11, 2003 (nonpatent document 1) discloses a technique in which debug information acquired with probes is collected through a network. Unlike the method disclosed in the patent document 1, the method disclosed in the nonpatent document 1 does not limit a probe to be inserted; that is, all probes are inserted into software. When the software is executed, a range of probes used to collect information is instead limited by use of random numbers so that the amount of information to be collected is reduced, and so that it becomes possible to avoid an increase in execution time caused by the information collection. According to the disclosed technique, a cause of a failure (bug point) is estimated by statistically analyzing the whole collected information.

### SUMMARY OF THE INVENTION

In the patent document 1, a probe insertion range is limited; also, memory resources and the overhead of the execution time are limited. In addition, a developer specifies the probe insertion range. Therefore, detailed information can be collected according to the characteristics of various kinds of devices and test conditions. However, repeatedly collecting information from a large number of devices involves a large amount of time, which is a problem to be solved.

Further, in the nonpatent document 1, because a range of probes used to acquire information is limited by use of random numbers, the overhead of the execution time is limited. Therefore, the task of specifying probes by the developer is avoided. However, because all probes are inserted into a program beforehand, the overhead given to memory resources is large, which is a problem to be solved.

To be more specific, the technologies disclosed in the above-described documents have a problem that when debug information is acquired from a large number and various kinds of devices, the reduction in memory resources and the reduction in probe execution time are not compatible with the reduction in the task of collecting information by the developer. In addition, even if the technologies disclosed in both of the documents are combined, the deviations in debug information collected from probes inevitably occur. This hinders software from being efficiently and rapidly developed. This is a problem that is left unsolved.

An object of the present invention is to provide a debug information collection method that is capable of reducing both a load on the device side and a load on the developer side at the same time and that is capable of acquiring uniform debug information without deviations.

According to one aspect of the present invention, the invention provides a debug information collection method that inserts probes into software so as to collect debug information before the software is distributed to a plurality of devices and that collects the debug information which is acquired by executing the software in each of the devices, said debug information collection method comprising the steps of:

determining a total set of insertion positions at which probes can be inserted into the software;

extracting a subset from the total set to determine the population of insertion positions of probes to be inserted into the software;

determining, on a device basis, the number of insertion positions of probes to be inserted;

selecting, from the population, insertion positions of probes, the number of which is equivalent to the determined number of insertion positions, and inserting probes into the software at the selected insertion positions; and

distributing, to the devices, the software into which the probes have been inserted.

The number of insertion positions of probes to be inserted is determined on a device basis according to storage capacity of each device or the performance of CPUs thereof. Insertion positions of probes are selected as many as the determined number of insertion positions from the population by use of random numbers, and probes are then inserted into the software at the selected insertion positions.

With reference to insertion counts of probes that have been inserted into software, the software having been distributed in the past, the population of probe insertion positions is determined from a subset of insertion positions with fewer insertion counts.

With reference to debug information that has been collected from probes inserted into the software, the software having been distributed in the past, an execution count of each probe is determined from the debug information, and the population of probe insertion positions is then determined from a subset of probe insertion positions with fewer execution counts.

An execution count of each probe is determined from the debug information, and the population of probe insertion positions is then determined from a subset of probe insertion positions with fewer counts of execution which is made during the occurrence of a failure.

According to the present invention, it is possible to reduce a load on the device side and a load on the software developer side and to speed up the failure-cause analysis of distributed software.

### BRIEF DESCRIPTION OF TEE DRAWINGS

FIG. 1 is a diagram illustrating an embodiment of a software distribution system according to the present invention;

FIG. 2 is a diagram illustrating an example of a probe information file 123 stored in the software distribution unit;

FIG. 3 is a diagram illustrating an example of an execution device information file 124 stored in the software distribution unit;

FIG. 4 is a diagram illustrating an example of a debug information file 132 stored in a debug information collection unit;

FIG. 5 is a flowchart illustrating an example of debug information collection processing; and

FIG. 6 is a flowchart illustrating, in detail, probe selection processing shown in FIG. 5.

### DESCRIPTION OF THE PREFERRED EMBODIMENTS

Embodiments of the present invention will be described with reference to the drawings as below.

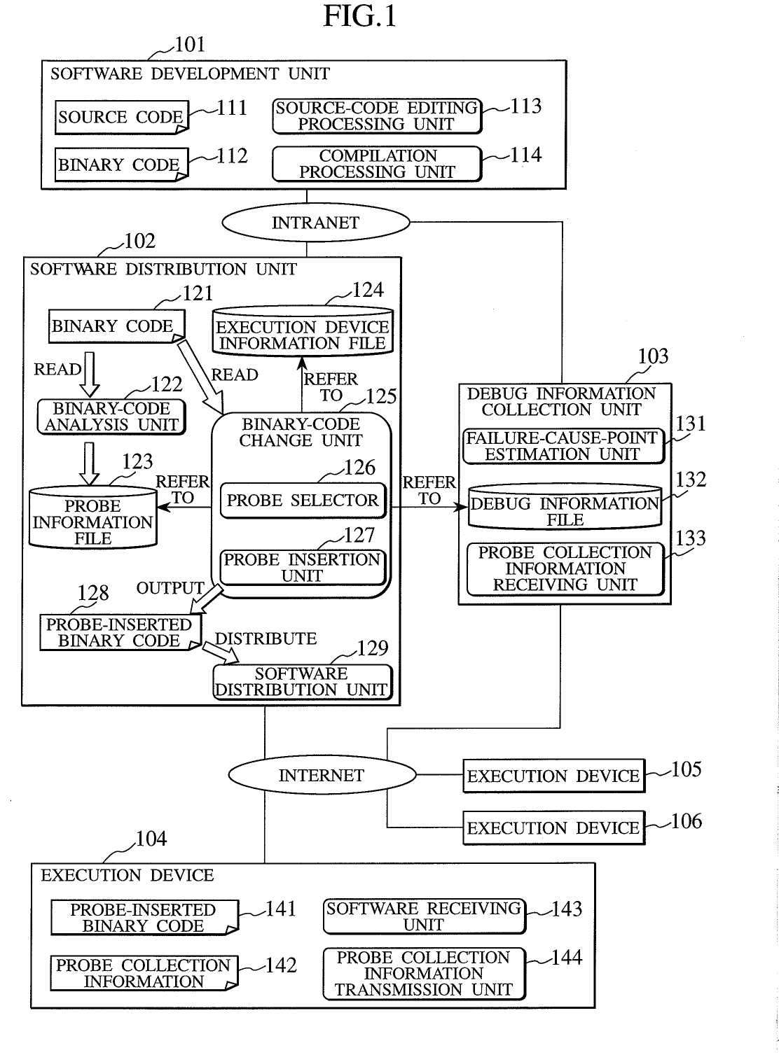

FIG. 1 is a diagram illustrating an embodiment of a software distribution system according to the present invention. This software distribution system includes a software development unit 101, a software distribution unit 102, a debug information collection unit 103, and a plurality of execution devices (devices) 104, 105, and 106. First of all, how these units are associated with one another will be described.

A software developer uses the software development unit 101 to develop software so that executable binary code is generated. The generated binary code is transmitted to the software distribution unit 102 through an intranet, or the like. The software distribution unit 102 inserts probes into the binary code, before distributing the binary code to the execution devices 104, 105, and 106 through the Internet, or the like. Each of the execution devices executes the distributed binary code to provide an owner of the execution device in question with services. At the same time, the execution device collects debug information acquired by the probes and then transmits the debug information to the debug information collection unit 103. The debug information collection unit 103 accumulates the debug information transmitted from each of the execution devices and then generates information used to estimate a cause of a failure by means of statistical analysis, or the like. The information is supplied to the software developer through the software development unit 101, or the like. Next, an internal configuration of each unit will be described.

The software development unit 101 includes data such as source code 111 and binary code 112 and has functions of a source-code editing processing unit 113, a compilation processing unit 114, and the like. The source-code editing processing unit 113 helps the software developer to create the source code 111. The compilation processing unit 114 converts the source code 111 into the binary code 112. The binary code 112 is transmitted to the software distribution unit 102 according to a judgment by the developer.

The software distribution unit 102 stores, as binary code 121, the binary code 112 that is transmitted from the software development unit 101. A binary-code analysis unit 122 analyzes the binary code 121 to extract points at which probes can be inserted. The extracted probe insertion points are stored in a probe information file 123. In addition, a list of execution devices, which are targets of software distribution, is stored in an execution device information file 124. The binary-code change unit 125 inserts probes into the binary code 121. In this case, the binary-code change unit 125 determines the number of probes and insertion positions with reference to the execution device information file 124, the probe information file 123, and a debug information file 132. The binary-code change unit 125 includes functional modules such as a probe selector 126 and a probe insertion unit 127. The binary code, into which the probes have been inserted, is stored as probe-inserted binary code 128. A software distribution unit 129 transmits the probe-inserted binary code 128 to the execution device 104, and the like.

The execution device 104 requests the software distribution unit 102 to distribute software (binary code). A software receiving unit 143 receives the probe-inserted binary code 141 and then stores the probe-inserted binary code 141 as such. The probe-inserted binary code 141 is executed in response to a trigger (for example, startup by a user), and probe collection information 142 is acquired as a result of the execution. The probe collection information, which can be acquired at this point of time, is limited to information about probes that have been inserted in the software distribution unit 102. As a matter of course, information about probes, which have not been inserted, can not be acquired. The acquired probe collection information 142 is transmitted to the debug information collection unit 103 by a probe collection information transmission unit 144.

The debug information collection unit 103 receives the probe collection information file 142 from the execution device 104, or the like, through a probe collection information receiving unit 133 and then stores the probe collection information file 142 as a debug information file 132. In addition, by use of the debug information file 132, a failure-cause-point estimation unit 131 estimates probes relating to a cause of a failure that has occurred at the time of the software execution and then creates a list of probes whose possibility of having caused the failure is high. This list is given to the software developer so that a cause of a software failure is analyzed on the basis of the list. This analysis requires a fixed quantity of data. A fixed length of time is taken before software is executed a sufficient number of times in each execution device so that a sufficient amount of data is accumulated in the debug information file 132.

In the configuration of this system, the binary-code change unit 125 of the software distribution unit 102 includes the probe selector 126 and the probe insertion unit 127. With reference to the execution device information file 124, the probe information file 123, and the debug information file 132, the probe selector 126 selects probes so that probes to be inserted into the binary code 121 become uniform without deviations. Moreover, the probe insertion unit 127 determines probe insertion positions, or the like, in response to the performance of each execution device.

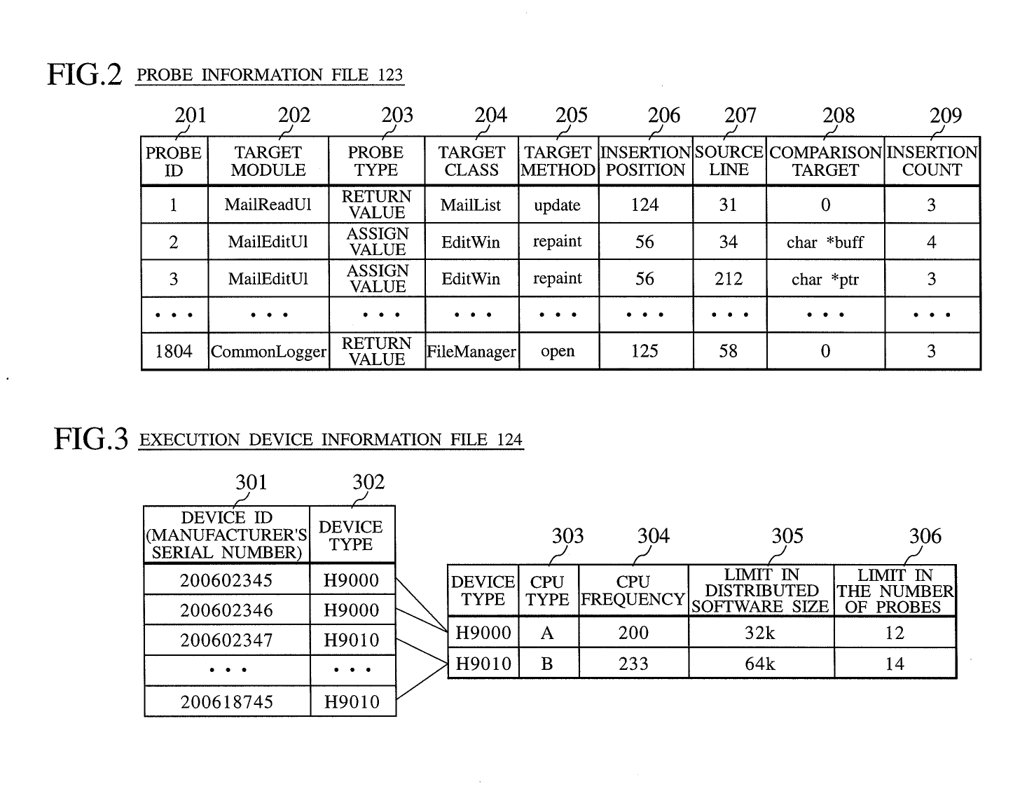

FIG. 2 is a diagram illustrating an example of the probe information file 123 stored in the software distribution unit 102. Here, a program for transmitting/receiving electronic mails is assumed as target software. “Probe ID” 201 is assigned to each probe to be inserted so that the each probe can be identified. “Target module” 202 indicates modules to which each probe belongs. Here, for example, each probe belongs to a module having a name of MailReadUI, MailEditUI, CommonLogger, or the like. “Probe type” 203 indicates kinds of probes. In this case, two kinds of probes are shown: a “return value” used to check a return value of a function; and an “assign value” used to check a value that is assigned to a variable such as a pointer. Besides them, it is also possible to adopt other kinds of probes including: an “assertion” used to check a truth value of a conditional statement that is inserted by the software developer; and “coverage” used to check a branch direction of a branch point.

“Target class” 204, “target method” 205, and “insertion position” 206 are information used to identify an insertion point of each probe. Here, on the assumption that a program format such as Java (registered trademark) is used, an example is shown in which a command sequence is identified by a class and a method so as to identify the number of offset bytes from the top of the command sequence on the basis of an insertion position. However, other program formats may also be adopted. “Source code line” 207 is information that indicates a position corresponding to each probe in the source code 111. When a probe which is presumed to be associated with a failure is determined the software developer can examine a cause of the failure with priority given to a portion around the source code line 207 corresponding to the probe. In addition, in this embodiment, instead of using a value acquired in the probe as an inspection result just as it is, a result of the comparison between the acquired value and a specific value is used as an inspection result. “Comparison target” 208 indicates a specific value or variable to be compared. “Insertion count” 209 is a value that indicates the number of times each probe has been inserted. When software is distributed to one execution device, a probe group constituted of a constant number of probes is inserted into the software. Accordingly, one is added to “insertion count” corresponding to each inserted probe group.

In the example shown in FIG. 2, a probe whose probe ID is 1 is a return-value type probe in a MailReadUI module. This probe is inserted into the 124th byte of “update” method in “Mail List” class. Moreover, this probe returns the result of the comparison between check data and 0. The number of times the probe has been inserted into the distribution binary code until now is three times.

FIG. 3 is a diagram illustrating an example of the execution device information file 124 stored in the software distribution unit 102. “Device ID” 301 is used to identify each execution device. In this case, a production number, which is assigned to each execution device at the time of shipment, is used as the device ID. “Device type” 302 includes H9000 and H9010, which are an old model and a new one, respectively. When these two models are compared with each other, “CPU type” 303 of H9000 and that of H9010 are “A” and “B,” respectively. “CPU frequency” 304 of H9000 and that of H9010 are “200” MHz and “233” MHz, respectively. Thus, the performance of the two models differs from each other. In addition, because memory resources of built-in equipment are limited, an upper limit is often put on the size of distributable software. Here, “limit in distributed software size” 305 is a limit in the size of software that can be received from the software distribution unit 102. The two models have different values. In the case of H9000, the limit in software size is 32K bytes; on the other hand, in the case of H9010, the limit in software size is 64K bytes. As a result, “upper limit in the number of probes” 306 shows different values for the two models: upper limits in the number of probes of H9010 and H9010 are set to 12 and 14, respectively.

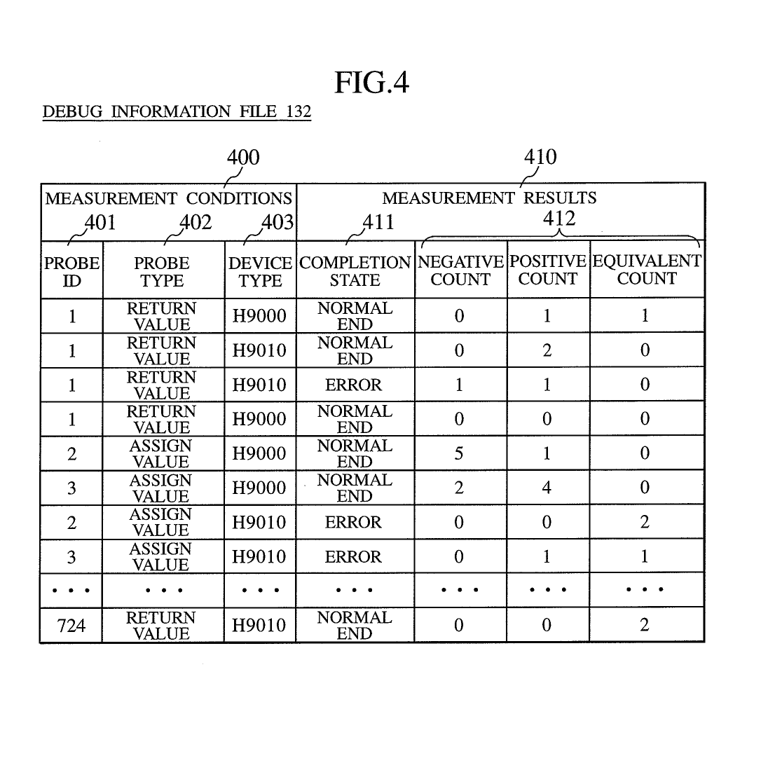

FIG. 4 is a diagram illustrating an example of the debug information file 132 stored in the debug information collection unit 103. Data of the debug information file 132 is grouped into “measurement conditions” 400 and “measurement results” 410. The “measurement conditions” 400 are constituted of “probe ID” 401, “probe type” 402, and “execution device type” 403. Here, it is shown that measurement with a probe identified by a probe ID=1 has been executed four times. The probe ID of this probe is “1,” and the probe type thereof is “return value”. The number of times the measurement has been executed by H9000 is twice, and the number of times the measurement has been executed by H9010 is also twice.

The “measurement results” 410 are constituted of “completion state” 411 and “comparison result count” 412. The “completion state” 411 is information indicating a software completion state, the information being collected together with information acquired from each probe. Here, “normal end” and “error” are used to identify two states: a state in which software has been completed without an error; and a state in which software has been terminated as a result of the occurrence of an error such as a crash. On the assumption that comparison results of each probe are classified into “negative count: <,” “positive count: >,” and “equivalent count: =,” the “comparison result count” 412 indicates the number of times each classification has been counted. For example, the data when the probe ID=1 shows that measurement with this probe has been executed twice and has been completed with the completion state of “normal end,” and that the number of times the comparison result is positive is once, whereas the number of times the comparison result is equivalent is once.

The debug information file 132 is used to select probes to be inserted so that when the software is distributed next time, uniform debug information can be collected efficiently.

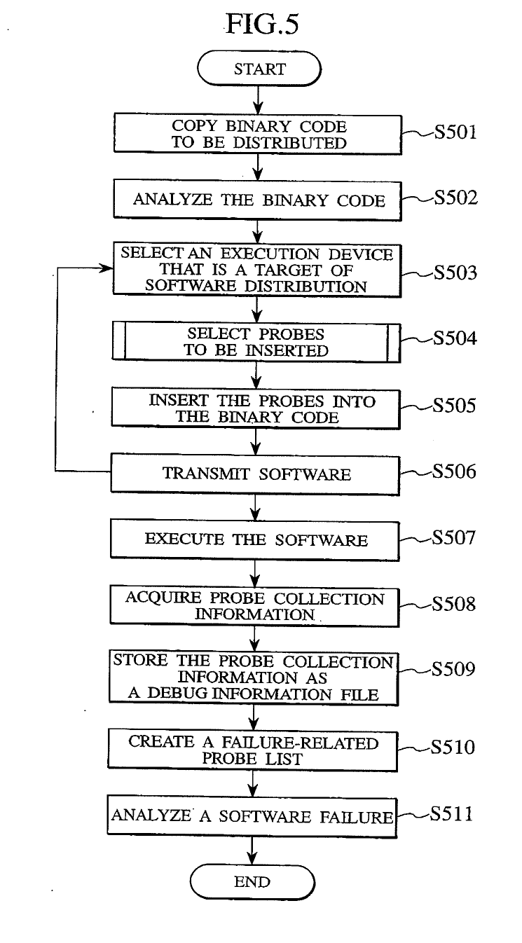

FIG. 5 is a flowchart illustrating an example of the overall debug information collection processing according to the present invention. Processing steps will be successively described as below.

Step S501: in order to distribute the binary code which has been created by the software development unit 101, the binary code is copied to the software distribution unit 102.

Step S502: the binary-code analysis unit 122 analyzes the binary code 121 that is a target to be distributed and thereby lists probes that can be inserted. For example, method call points are extracted. These method call points are used as insertion points of probes in which a “return value” of the method is checked. The extracted probe insertion points are added to the probe information file 123. In this manner, the probe information file 123 covering the whole binary code, which is a target to be distributed, is created.

Step S503: one execution device (device), which is a target to which software is distributed, is selected. In this case, the software distribution unit 102 autonomously selects an execution device, to which software is distributed, on the basis of the execution device information file 124 or distributes software in response to a software distribution request from the execution device 104.

Step S504; for the execution device selected as the distribution target, the binary-code change unit 125 selects probes to be inserted. In this case, the number of probes is determined according to the execution device; the population of probes to be inserted is determined according to an insertion history. Details will be described later.

Step S505: the selected probes are inserted into the binary code 121 to generate the probe-inserted binary code 128.

Step S506: the software distribution unit 129 transmits the probe-inserted binary code 128 to the execution device 104 that is the distribution target.

Step S507: the execution device 104 executes the received software.

Step S508: the probe collection information 142 is acquired as a result of the execution of the software, and the probe collection information 142 is then transmitted to the debug information collection unit 103.

Step S509: the debug information collection unit 103 stores the acquired probe collection information 142 in the debug information file 132.

Step S510: the failure-cause-point estimation unit 131 estimates probes relating to a failure that has occurred at the time of the execution and then creates a probe list.

Step S511: the software developer analyzes a cause of the software failure on the basis of the probe list.

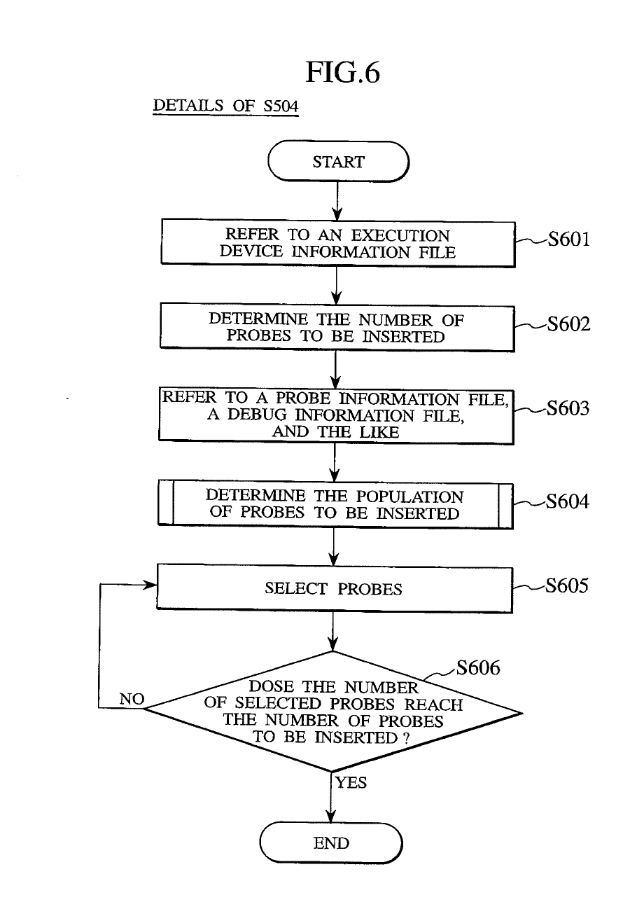

FIG. 6 is a flowchart illustrating in detail the probe selection processing (step S504) shown in FIG. 5 described above.

Step S601: with reference to the execution device information file 124, the binary-code change unit 125 acquires information relating to an execution device that is a target to which software is distributed. The information to be acquired includes the device type, the CPU type, the CPU frequency, the limit in distributed software size, and the upper limit in the number of probes, as shown in FIG. 3.

Step S602: the number of probes to be inserted is determined on the basis of the acquired execution device information file 124. The number of probes is properly determined by the performance of the execution device that is the distribution target. Moreover, when software is repeatedly distributed to the same execution device, the number of probes may also differ on a distribution basis.

Here, several methods for determining the number of probes according to an execution device will be specifically described as below.

(1) A method in which the number of probes is determined on the basis of a limit in the size of distributable software:

If the number of probes to be inserted is increased, the size of the binary code also increases. For this reason, the maximum number of probes (the upper limit in the number of probes 306) which does not cause the size of the binary code to exceed a limit value is adopted as the number of probes to be inserted. For example, if the number of probes to be inserted has the proportional relationship with the increase in the size of the binary code, the maximum number of probes n is adopted as the number of probes when the maximum number of probes n satisfies the equation below where the size of the binary code before insertion is Xo, the size of the binary code when all probes the number of which is N are inserted is Xp, and the upper limit in the size of the distributable binary, code is M.

n(Xp−Xo)/N+Xo<M

This makes it possible to collect debug information with storage areas of each execution device utilized to the fullest.

(2) A method that determines the number of probes on the basis of CPU types and operating frequencies:

It is assumed that a constant, which is predetermined according to the CPU type, is defined as the number of probes. In another case, the proportional relationship between operating frequencies and the number of probes is predetermined so that the number of probes is determined. Accordingly, in the case of an execution device with a high-computing-power CPU, and that can spare a sufficient amount of processing time, measurement is performed with a large number of probes. On the other hand, in the case of an execution device with a low-computing-power CPU, and that cannot spare a sufficient amount of processing time, measurement is performed with only a few probes. As a result, it becomes possible to collect debug information according to the capacity of the execution device. Incidentally, a method in which the number of probes used for measurement is limited on the execution device side may also be used jointly. In that case, because the number of probes used for measurement is changed on an execution device basis, it is possible to collect information according to the CPU performance by transmitting the number of probes from the software distribution unit 102 to each execution device and by acquiring information only from probes, the number of which has been transmitted.

(3) Other methods for determining the number of probes:

For example, the following methods may also be adopted: a determination method that is based on the contents of a contract made by a user to use software; a determination method that is based on the position information of a device acquired by GPS positioning; and a determination method that is based on whether or not a network band and a network connection are always available. In addition, a plurality of determination methods, which include the above-described determination methods, may also be used. A determination method in which the minimum number of probes is selected from among the numbers of probes calculated by the above-described determination methods may also be used.

Step S603: the binary-code change unit 125 further refers to the probe information file 123, and the debug information file 132, and thereby acquires information about a total set of probe insertion points.

Step S604: when probes to be inserted are selected, the population of probes to be selected is determined. This population is a subset of the total set of probes, which is acquired from the probe information file 123. To be more specific, probes to be selected are determined not from the total set, but from the population.

Here, some specific methods for determining the population from a probe insertion history will be described.

(4) A method for determining the population according to insertion counts of each probe:

A probe having the maximum value of the insertion count, which is obtained from the probe information file 123, is excluded such that the other probes constitute the population. In other words, probes with fewer insertion counts form the population. For example, in FIG. 2, in a case where ID=2, an insertion count is the maximum (four times). Accordingly, this probe is excluded from the population. As a result of this operation, probes with fewer insertion counts are selected. Accordingly, it is possible to prevent insertion counts of each probe from deviating and to uniformalize them. If the insertion counts of probes deviate from one another, the amount of collected information about a specific probe becomes small; accordingly, the wait time becomes longer before information required to estimate a cause of a failure is obtained. By eliminating the deviations in insertion count, it is possible to estimate a failure cause in a shorter period of time.

(5) A method for determining the population according to the debug information in the past:

This is a method that is based on execution counts of each probe and execution counts at the time of the occurrence of an error. According to the debug information file 132 shown in FIG. 4, the probe whose probe ID=1 is executed four times. Among the four times, an error has occurred once. On the other hand, the probe whose probe ID=2 is executed twice. Among the two times, an error has occurred once. By selecting probes with fewer execution counts as the population of probes, it is possible to collect information about the selected probes in a shorter period of time. In another case, by selecting probes with fewer error occurrences, it is possible to collect information more easily at the time of the occurrence of an error. This eliminates the deviations in execution count of each probe, which makes it possible to shorten the wait time before information required for estimation is collected.

(6) Other methods for determining the population:

For example, the following methods may also be adopted: a method in which probe execution counts are compared on a module basis so that the population is selected on a module basis; and a method in which combinations of probes to be inserted for each distribution are checked from a probe insertion history so that the deviations in combination of probes are averaged. In addition, a plurality of determination methods, which include the above-described determination methods, may also be used. For example, there is also a method in which a union or product set of the population acquired by each determination method is defined as the population.

Step S605: by use of a random number, or the like, one probe is selected from the probe population determined by the above methods. In the probe information file 123, one is added to the “insertion count” 209 corresponding to each selected probe.

Step S606: if the number of selected probes reaches the number of probes to be inserted, which has been determined in the step S602, the selection of probes is completed; otherwise, the process returns to the step S603 where a probe is to be selected again.

Thus, according to this embodiment, because the number of probes to be inserted is determined according to the performance of each execution device, an excessive load is not placed on each execution device. In addition, because the population is determined on the basis of the probe insertion history, it is possible to minimize the deviations of probes to be inserted. As a result, it is possible to reduce both a load on the device side and a load on the developer side at the same time and to acquire uniform debug information. This contributes to the speeding-up of the software-failure-cause analysis.

The above embodiment describes the example in which debug information about a single binary code is collected. However, the present invention can also be applied to a case where debug information about a plurality of binary codes is collected. Moreover, the above embodiment describes the example in which probes are inserted into binary code. However, probes may also be inserted into source code. In that case, instead of the binary code, the source code may be located in the software distribution unit 102, and the software distribution unit 102 may be provided with a compilation processing unit.

The above embodiment describes the case where the software distribution unit 102, the debug information collection unit 103, and the execution devices 104, 105, and 106 are connected to one another through public networks such as the Internet. However, in-house networks such as an intranet may also be used to connect them.

In other words, the present invention can also be applied to improvement in software before the execution device 104, or the like, is shipped. In addition, it may also be configured such that software is distributed through an intranet before the shipment of the execution device 104, whereas debug information is collected through the Internet after the shipment of the execution device 104. In other words, the present invention can also be applied to a case where services of software distribution are not provided.

In this embodiment, the example in which the software development unit 101, the software distribution unit 102, and the debug information collection unit 103 are connected to one another through an in-house network such as an intranet is shown. However, public networks such as the Internet may also be used to connect them. To be more specific, even if a software distribution function and a debug information collection function, which are achieved by the software distribution unit 102 and the debug information collection unit 103, respectively, are supplied to a software developer as a pay or free service, the present invention can be applied.

What is claimed is:

1. A debug information collection method that inserts probes into software so as to collect debug information before the software is distributed to a plurality of devices and that collects the debug information which is acquired by executing the software in each of the devices, said method comprising the steps of:
determining a total set of insertion positions at which probes can be inserted into the software;
extracting a subset from the total set to determine the population of insertion positions of probes to be inserted into the software;
determining, on a device basis, the number of insertion positions of probes to be inserted;
selecting, from the population, insertion positions of probes as many as the determined number of insertion positions and inserting probes into the software at the selected insertion positions; and
distributing, to the devices, the software into which the probes have been inserted.

2. The debug information collection method according to claim 1, wherein
the number of insertion positions of probes to be inserted is determined on a device basis according to the storage capacity of each device or the performance of CPUs thereof; and
insertion positions of probes are selected as many as the determined number of insertion positions from the population by use of random numbers, and probes are then inserted into the software at the selected insertion positions.

3. The debug information collection method according to claim 1, wherein
with reference to insertion counts of probes that have been inserted into software, the software having been distributed in the past, the population of probe insertion positions is determined from a subset of insertion positions with fewer insertion counts.

4. The debug information collection method according to claim 1, wherein
with reference to debug information that has been collected from probes inserted into software, the software having been distributed in the past, an execution count of each probe is determined from the debug information, and the population of probe insertion positions is then determined from a subset of probe insertion positions with fewer execution counts.

5. The debug information collection method according to claim 4, wherein
an execution count of each probe is determined from the debug information, and the population of probe insertion positions is then determined from a subset of probe insertion positions with fewer counts of execution which is made during the occurrence of a failure.

6. A debug information collection method for collecting debug information of software that is executed in a plurality of built-in devices, said debug information collection method comprising the steps of:
generating software to be distributed by inserting probes into the software from probe information including insertion positions of probes, device information about the built-in devices, and debug information;
distributing, to each of a plurality of the built-in devices, software into which different probes are inserted;
acquiring probe collection information of the distributed software from a plurality of the built-in devices; and
updating the debug information on the basis of the acquired probe collection information.

7. The debug information collection method according to claim 6, wherein
said step for inserting probes into the software so as to generate software to be distributed comprises the steps of:
on a device basis, determining the number of probe insertion positions according to the storage capacity of each device or the performance of CPUs thereof; and
selecting, from the population, probe insertion positions as many as the determined number of probe insertion positions by use of random numbers and then inserting probes into the software at the selected probe insertion positions.

8. The debug information collection method according to claim 6, wherein
said step for inserting probes into the software so as to generate software to be distributed comprises the step of:
with reference to insertion counts of probes that have been inserted into software, the software having been distributed in the past, inserting a probe at each insertion position with fewer insertion counts.

9. The debug information collection method according to claim 6, wherein
said step for inserting probes into the software so as to generate software to be distributed comprises the step of:
with reference to debug information that has been collected from probes inserted into software, the software having been distributed in the past, determining an execution count of each probe from the debug information and then inserting a probe at each probe insertion position with fewer execution counts.

10. The debug information collection method according to claim 6, wherein
said step for inserting probes into the software so as to generate software to be distributed comprises the step of:
determining an execution count of each probe from the debug information and then inserting a probe at each probe insertion position with fewer counts of execution which is made during the occurrence of a failure.

11. A debug information collection system for collecting debug information of software, said debug information collection system comprising:
a plurality of execution devices, each of which executes software to be debugged so that debug information is generated;
a software development unit for developing the software so that executable binary data is created;
a software distribution unit for inserting probes into the binary data to create the software to be debugged, and then for distributing the software to be debugged to the devices; and
a debug information collection unit for collecting debug information of the software from the execution devices, the software having been distributed to the execution devices so that the software is executed by the execution devices.

12. The debug information collection system according to claim 11, wherein
said software distribution unit comprises:
a binary-code analysis unit for analyzing the software to be debugged to extract probe insertion positions at which probes can be inserted;
a probe information storage unit for storing the probe insertion positions that have been extracted by the binary-code analysis unit;
an execution device information storage unit for storing a list of execution devices to which the software with inserted probes is distributed; and
a binary-code change unit for, with reference to the information stored in the probe information storage unit, the information stored in the execution device information storage unit, and the debug information collected by the debug information collection unit, inserting probes into the binary data to generate the software to be debugged.

13. The debug information collection system according to claim 12, wherein
on an inserted probe ID basis, said probe information storage unit includes a storage area for storing:
a module name of a module into which each probe is inserted;
a probe type indicating a target which each probe checks;
insertion position information used to identify an insertion position of each probe;
a target value to be compared, which is a value expected by each probe; and
an insertion count value, which is the number of times each probe has been inserted into the module.

14. The debug information collection system according to claim 13, wherein
a probe type of the probe information storage unit stores probe types including:
a probe type indicating whether or not to check a return value of a function;
a probe type indicating whether or not to check an assign value that is assigned to a variable;
a probe type indicating whether or not to check a truth value of a conditional statement; and
a probe type indicating whether or not to check a branch direction of a branch point.

15. The debug information collection system according to claim 12, wherein
on an execution device basis, said execution device information storage unit includes:
type information indicating a model of each execution device;
CPU type information indicating the performance of a CPU;
size information indicating a size limit of software to be distributed: and
a probe upper limit indicating an upper limit in the number of probes that can be inserted.

16. The debug information collection system according to claim 11, wherein:
the debug information collected by the debug information collection unit is updated with measurement results for each of measurement conditions constituted of a probe ID, a probe type, and an execution device type, and
the measurement results including:
information about a state at the time of the termination of the software execution, the information being collected with each probe;
comparison result acquired on a probe basis; and
the counts the information and the comparison result.
